(19) United States
(12) Patent Application Publication
(10) Pub. No.: US 2008/0197910 A1
(43) Pub. Date: Aug. 21, 2008

(54) Input processing circuit and switch input circuit using the same

(75) Inventor: Hirofumi Isomura, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/068,763

(22) Filed: Feb. 12, 2008

(30) Foreign Application Priority Data
Feb. 16, 2007 (JP) 2007-36213
Oct. 3, 2007 (JP) 2007-259979

(51) Int. Cl. G05F 1/00

(52) U.S. Cl. 327/520

(57) ABSTRACT

An input processing circuit implemented on a semiconductor integrated circuit includes an input terminal for receiving an input signal, a first diode coupled between the input terminal and a power line, a second diode coupled between the input terminal and a ground line, a first MOSFET having a gate and drain coupled together to the input terminal, and a source coupled to the ground line, a second MOSFET coupled to the first MOSFET to construct a current mirror circuit, a current-to-voltage conversion circuit coupled between the power line and the second MOSFET to convert an electric current flowing through the second MOSFET to a voltage, and a determination circuit configured to determine a state of the input signal based on a level of the output voltage of the current-to-voltage conversion circuit.

### CROSS REFERENCE TO RELATED APPLICATION

This application is based on and incorporates herein by reference Japanese Patent Applications No. 2007-36213 filed on Feb. 16, 2007 and No. 2007-259979 filed on Oct. 3, 2007.

### FIELD OF THE INVENTION

The present invention relates to an input processing circuit implemented on a semiconductor integrated circuit and relates to a switch input circuit using the input processing circuit.

### BACKGROUND OF THE INVENTION

JP-A-2005-149092 discloses a switch input circuit for detecting an ON/OFF state of an ignition switch of a vehicle. A switch input circuit 1 illustrated in FIG. 8 has a similar structure to the switch input circuit disclosed in JP-A-2005-149092. The switch input circuit 1 is formed on a circuit board and includes a zener diode 4, resistors 5, 6, a transistor 7, and a complementary metal-oxide-semiconductor integrated circuit (CMOS IC) 9. The zener diode 4 limits a battery voltage VB that is supplied by a battery 2 through an ignition switch 3. The resistors R5, R6 construct a voltage divider circuit for dividing the battery voltage VB. A voltage across the resistor 6 is applied to the transistor 7. An input processing circuit 8 is implemented on the CMOS IC 9. The input processing circuit 8 includes input protection diodes 10, 11, a pull-up resistor 12, and a Schmitt inverter 13, which outputs a detection signal SIG.

The switch circuit 1 may be modified as illustrated in FIG. 9. In a switch circuit 14 illustrated in FIG. 9, the transistor 7 of the switch input circuit 1 is replaced with a metal oxide semiconductor field-effect transistor (MOSFET) 15, and the voltage across the resistor 6 is limited by the input protection diodes 10, 11. The input protection diodes 10, 11, the resistor 6, and the MOSFET 15 construct an input processing circuit 16. The input processing circuit 16 is implemented on a CMOS IC 17.

The switch input circuits 1, 14, illustrated in FIGS. 8, 9, can be respectively constructed with the CMOS ICs 9, 17, which are fabricated in a low voltage 5.5 volts (V) CMOS process. However, according to the switch input circuit 1 illustrated in FIG. 8, the number of circuit parts externally added to the CMOS IC 9 is large. Therefore, when it is required to detect ON/OFF states of many switches (e.g., door switch) besides the ignition switch, the number of the external circuit parts greatly increases. Accordingly, the cost and the size of the switch input circuit 1 greatly increase.

According to the switch input circuit 14 illustrated in FIG. 9, the number of circuit parts externally added to the CMOS IC 17 is small. However, since an electric current flows into a control power supply source (e.g., a series regulator) from the battery 2 through the ignition switch 3, the resistor 5, and the input protection diode 10, a control power supply voltage Vcc increases. As a result, a determination reference voltage Vref generated by a sensor input circuit 18 formed in the CMOS IC17 varies. Therefore, the sensor input circuit 18 may improperly determine a level of a sensor signal inputted from a sensor 14.

### SUMMARY OF THE INVENTION

In view of the above-described problem, it is an object of the present invention to provide an input processing circuit that is implemented on a semiconductor integrated circuit fabricated in a low voltage CMOS process and relates to a switch input circuit constructed with the input processing circuit and a small number of circuit parts externally added to the input processing circuit.

According to a first aspect of the present invention, an input processing circuit is implemented on a semiconductor integrated circuit and configured to be powered by a supply voltage supplied through first and second power lines. The input processing circuit includes an input terminal, first and second diodes, first and second transistors, a current-to-voltage conversion circuit, and a determination circuit. The input terminal receives an input signal. The first diode is coupled between the input terminal and the first power line. The second diode is coupled between the input terminal and the second power line. The first transistor has first and second output electrodes and one control electrode. The first output electrode and the control electrode are coupled to the input terminal. The second output electrode is coupled to the second power line. The second transistor is coupled to the first transistor to construct a current mirror circuit. The current-to-voltage conversion circuit is coupled between the first power line and the second transistor and configured to convert an electric current flowing through the second transistor to a voltage. The determination circuit is configured to determine a state of the signal received by the input terminal based on a level of the output voltage of the current-to-voltage conversion circuit.

According to a second aspect of the present invention, an input processing circuit is implemented on a semiconductor integrated circuit and configured to be powered by a supply voltage supplied through first and second power lines. The input processing circuit includes an input terminal, first and second diodes, first and second clamp circuits, first and second resistor circuits, and a determination circuit. The input terminal receives an input signal. The first diode is coupled between the input terminal and the first power line. The second diode is coupled between the input terminal and the second power line. The first clamp circuit is coupled between the input terminal and the second power line and includes at least one first transistor element connected in a diode configuration. The second clamp circuit is coupled between the first and second power lines through a resistor and has a same structure as the first clamp circuit. The first resistor circuit includes at least one first resistor element coupled in parallel with the first clamp circuit. The first resistor circuit is configured to output a first voltage dependent on a voltage drop across the first clamp circuit. The second resistor circuit includes at least one second resistor element coupled in parallel with the second clamp circuit. The second resistor circuit is configured to output a second voltage dependent on a voltage drop across the second clamp circuit. The determination circuit is configured to compare the first voltage with the second voltage and determine a state of the input signal received by the input terminal based on a result of the comparison.

### BRIEF DESCRIPTION OF THE DRAWINGS

The above and other objectives, features and advantages of the present invention will become more apparent from the following detailed description made with check to the accompanying drawings. In the drawings:

FIG. 1 is a circuit diagram illustrating an input switch circuit according to a first embodiment of the present invention;

FIG. 2 is a circuit diagram illustrating an input switch circuit according to a second embodiment of the present invention;

FIG. 3 is a circuit diagram illustrating an input switch circuit according to a third embodiment of the present invention;

FIG. 4 is a diagram illustrating waveforms of voltages in the input switch circuit of FIG. 3;

FIG. 5 is a diagram illustrating input and output characteristics of a first clamp circuit in the input switch circuit of FIG. 3;

FIG. 6 is a circuit diagram illustrating an input switch circuit according to a fourth embodiment of the present invention;

FIG. 7 is a diagram illustrating waveforms of voltages in the input switch circuit of FIG. 6;

FIG. 8 is a circuit diagram illustrating a conventional input switch circuit; and

FIG. 9 is a circuit diagram illustrating another conventional input switch circuit.

### DETAILED DESCRIPTION OF THE PREFERRED EMBODIMENTS

### First Embodiment

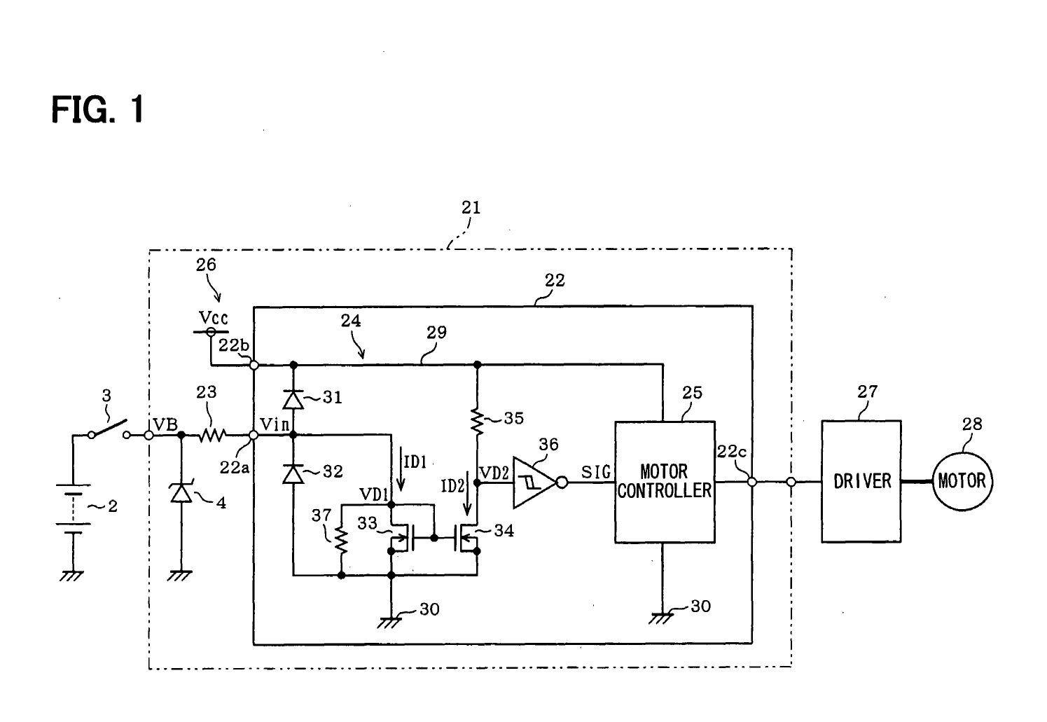

Referring to FIG. 1, a control circuit 21 according to a first embodiment of the present invention includes a zener diode 4, an integrated circuit (IC) 22 and a protection resistor 23. For example, the control circuit 21 is used to control a blower motor 28 of an air-conditioner of a vehicle. The control circuit 21 is formed on a circuit board. The zener diode 4 limits a battery voltage VB that is supplied by a battery 2 through an ignition switch 3. The IC 22 is fabricated in a low voltage CMOS process. The protection resistor 23 is coupled between the ignition switch 3 and an input terminal 22a of the IC 22.

The IC 22 includes an input processing circuit 24 and a motor control circuit 25. The input processing circuit 24 and the protection resistor 23 constructs a switch input circuit 26. The switch input circuit 26 detects an ON/OFF state of the ignition switch 3 and outputs a detection signal SIG indicative of the detected ON/OFF state to the motor control circuit 25. The motor control circuit 25 controls the blower motor 28 in accordance with input signals including the detection signal SIG through an output terminal 22c of the IC 22 and a motor derive circuit 27.

The IC 22 is powered by a power supply voltage Vcc (e.g., 5 volts) supplied through a power terminal 22b from a power supply circuit (not shown). The input processing circuit 24 includes input protection diodes 31, 32, N-channel MOSFETs 33, 34, a resistor 35, a Schmitt inverter 36, and a clamp resistor 37 having a high resistance. The input protection diode 31 is coupled between the input terminal 22a and a power line 29. The input protection diode 32 is coupled between the input terminal 22a and a ground line 30. The gates of the MOSFETs 33, 34 are coupled together, and the sources of the MOSFETs 33, 34 are coupled to the ground line 30. Thus, the MOSFETs 33, 34 construct a current mirror circuit. The resistor 35 is coupled between the power line 29 and the drain of the MOSFET 34. The Schmitt inverter 36 receives a drain voltage VD2 of the MOSFET 34 and outputs the detection signal SIG The clamp resistor 37 is coupled between the gate and source of the MOSFET 33. The gate and drain of the MOSFET 33 is coupled to the input terminal 22a of the IC 22.

The operation of the switch input circuit 26 is described below. When the ignition switch 3 is tuned on, an electric current ID1 flows from the battery 2 to the MOSFET 33 through the protection resistor 23, and an electric current ID2 flows through the MOSFET 34. The electric current ID2 depends on a size ratio (W/L ratio) between the MOSFETs 33, 34. At this time, an input voltage Vin appearing at the input terminal 22a is limited to a gate-source voltage VGS of the MOSFET 33. The gate and source of the MOSFET33 are coupled though the input protection diode 32.

If the power supply circuit, which is not shown in the drawings and supplies the power supply voltage Vcc to the IC 22, is a series regulator, the power supply voltage Vcc may increase due to an electric current that flows from the input terminal 22a into the power supply circuit through the input protection diode 31 and the power line 29. To prevent the electric current flowing into the power supply circuit, it is preferable that the following inequality be satisfied:

Vcc>(VGS−Vf) (1)

In the above inequality (1), Vf represents a forward bias voltage of the input protection diode 31. The drain voltage VD2 of the MOSFET 34 is given as follows:

VD2=Vcc−ID2−R35 (2)

In the above equation (2), R35 represents a resistance of the resistor 35. When the drain voltage VD2 is less than the a lower inverter threshold Vn of the Schmitt inverter 36, the detection signal SIG outputted from the Schmitt inverter 36 changes from low to high so that the switch input circuit 26 detects that the ignition switch 3 is turned on.

When the ignition switch 3 is tuned off, a drain voltage VD1 and a gate voltage of the MOSFET 33 is clamped to zero volts by the clamp resistor 37. As a result, the MOSFETs 33, 34 are turned off, and the drain voltage VD2 of the MOSFET 34 becomes equal to the power supply voltage Vcc. Since an upper inverter threshold Vp of the Schmitt inverter 36 is set less than the power supply voltage Vcc, the detection signal SIG outputted from the Schmitt inverter 36 changes from high to low so that the switch input circuit 26 detects that the ignition switch 3 is turned off. In this condition, a consumption current of the input processing circuit 24 is zero, because the MOSFET 34 is off.

An example of a procedure for determining circuit constants is described below. First, a resistance R23 of the protection resistor 23 is determined based on static resistance, and the size (W/L) of each of the MOSFETs 33, 34 is determined so that the gate-source voltage VGS can become a desired value. For example, the resistance R23 is set to 56 kilo-ohms (kΩ), and the desired value of the gate-source voltage VGS is set to 1.15 volts.

Then, an upper battery threshold VB1 is determined such that the state of the ignition switch 3 can be surely detected as “ON” when the battery voltage VB increases from zero volts during a period of time when the ignition switch 3 is on. For example, the upper battery threshold VB1 is set to 3.0 volts. Likewise, a lower battery threshold VB2 is determined such that the state of the ignition switch 3 can be surely detected as “OFF” when the battery voltage VB decreases during a period of time when the ignition switch 3 is on. For example, the lower battery threshold VB2 is set to 2.5 volts. Thus, although the ignition switch 3 remains on, the detection signal SIG outputted from the Schmitt inverter 36 changes from high to low when the battery voltage VB decreases to or less than the lower battery threshold VB2. When the detection signal SIG changes from high to low, the motor control circuit 25 stops the blower motor 28.

When the battery voltage VB is the upper battery threshold VB1, the drain current ID1 of the MOSFET 33 is given by the following equation:

ID1=(VB1−VGS)/R23 (3)

When a mirror ratio between the MOSFETs 33, 34 is set to 1:1, the resistance R35 of the resistor 35 needs to be set to satisfy the following inequality:

R35>(Vcc−Vn)/ID1 (4)

The following inequality is given by substituting the equation (3) into the above inequality (4):

R35>((Vcc−Vn)/(VB1−VGS))−R23 (5)

Then, the upper inverter threshold Vp is determined as described below. When the battery voltage VB is the lower battery threshold VB2, the drain current ID1 of the MOSFET 33 is given by the following equation:

ID1=(VB2−VGS)/R23 (6)

In this case, the drain voltage VD2 of the MOSFET 34 (i.e., input voltage of the Schmitt inverter 36) is given by the following equation:

VD2=Vcc−ID1−R35=Vcc−(VB2−VGS)−(R35/R23) (7)

Therefore, the upper inverter threshold Vp is given by the following equation:

Vp=Vcc−(VB231 VGS)·(R35/R23) (8)

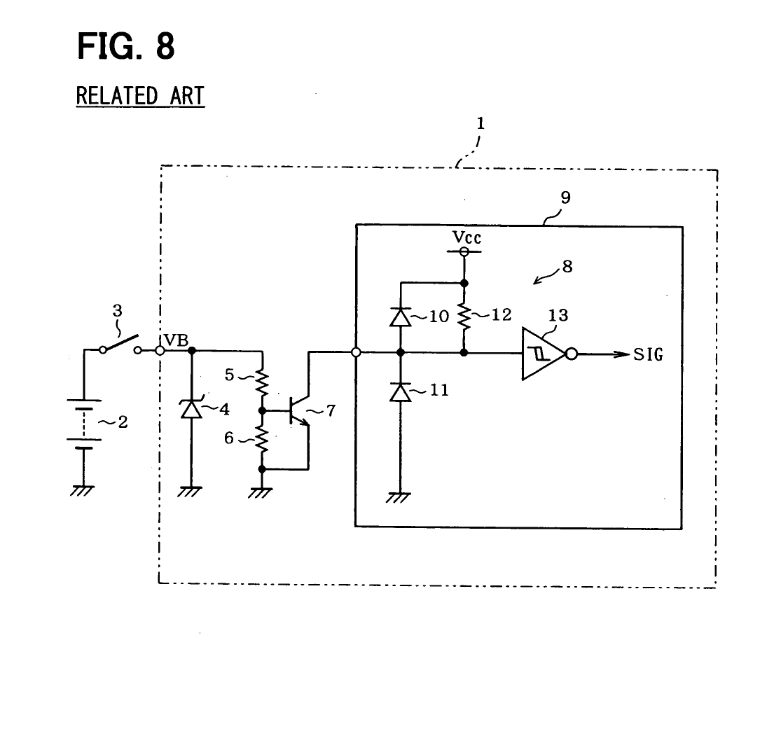

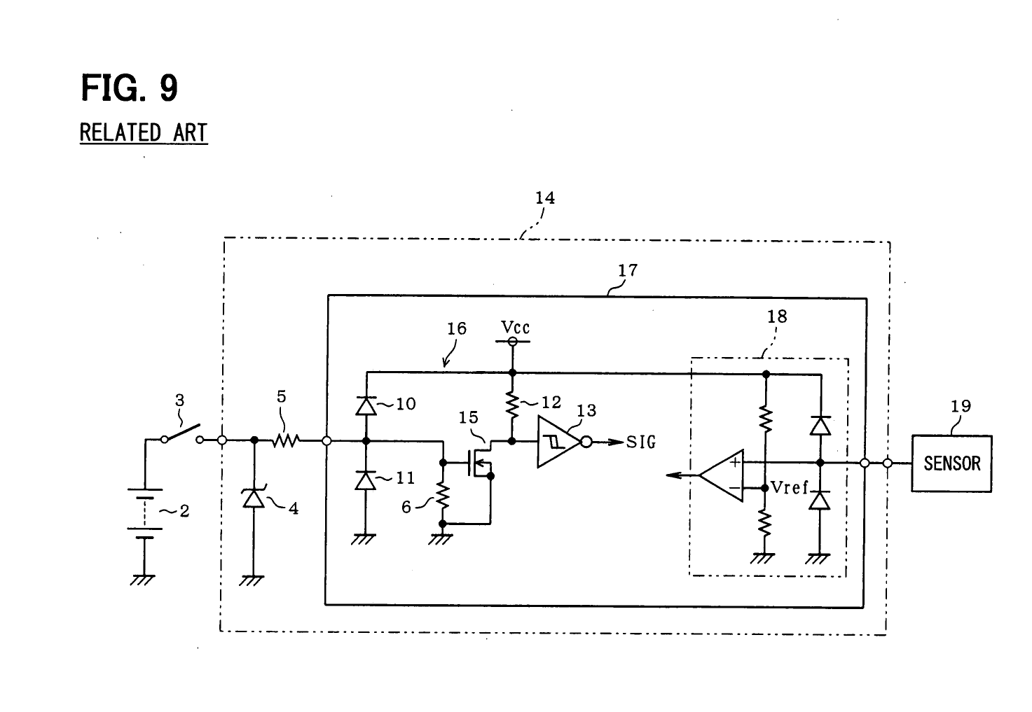

As described above, according to the first embodiment, the switch input circuit 26 includes the protection resistor 23 and the IC 22 having the input processing circuit 24. The switch input circuit 26 can be constructed simply by externally adding the protection resistor 23 between the ignition switch 3 and the input terminal 22a of the IC 22. Therefore, the manufacturing cost and size of the switch input circuit 26 can be reduced as compared to the prior art illustrated in FIGS. 8, 9.

The input processing circuit 24 formed to the IC 22 includes the input protection diodes 31, 32, the MOSFETs 33, 34 constructing a current mirror circuit, the resistor 35 serving as a current-to-voltage converter, and the Schmitt inverter 36 serving as a determination circuit. The input voltage Vin appearing at the input terminal 22a of the IC 22 is clamped to the gate-source voltage VGS of the MOSFETs 33, 34. In such an approach, the input voltage Vin can be surely maintained below 2 volts by adjusting the resistance R23 of the protection resistor 23 and the W/L size of the MOSFET 33, even if the battery voltage VB increases to 40 volts, for example, due to a load dump. Therefore, reliability of a gate oxide film formed in a CMOS process can be ensured, and the IC 22 can be fabricated in a low voltage CMOS process that withstands the power supply voltage Vcc. The detection level of the ON/OFF state can be adjusted by adjusting the resistance of the resistor 35 and the W/L size of the MOSFETs 33, 34.

The clamp resistor 37 is coupled between the gate and source of the MOSFET 33. In such an approach, when the ignition switch 3 is off, the gate potential of the MOSFET 33 is clamped to the source potential (i.e., ground potential) of the MOSFET 33 so that, the MOSFETs 33, 34 are surely maintained in the off state. The resistor 35 is coupled between the power line 29 and the MOSFET 34 and serves as a current-to-voltage converter. In such an approach, when the ignition switch 3 is on, a relationship between the battery voltage VB and the input voltage of the Schmitt inverter 36 (i.e., the drain voltage VD2 of the MOSFET 34) becomes linear so that the circuit constants can be easily designed. The determination circuit is constructed by the Schmitt inverter 36 instead of, for example, a combination of a reference voltage and a comparator. In such an approach, the size of the IC 22 can be reduced, and the determination signal SIG can be stabilized.

### Second Embodiment

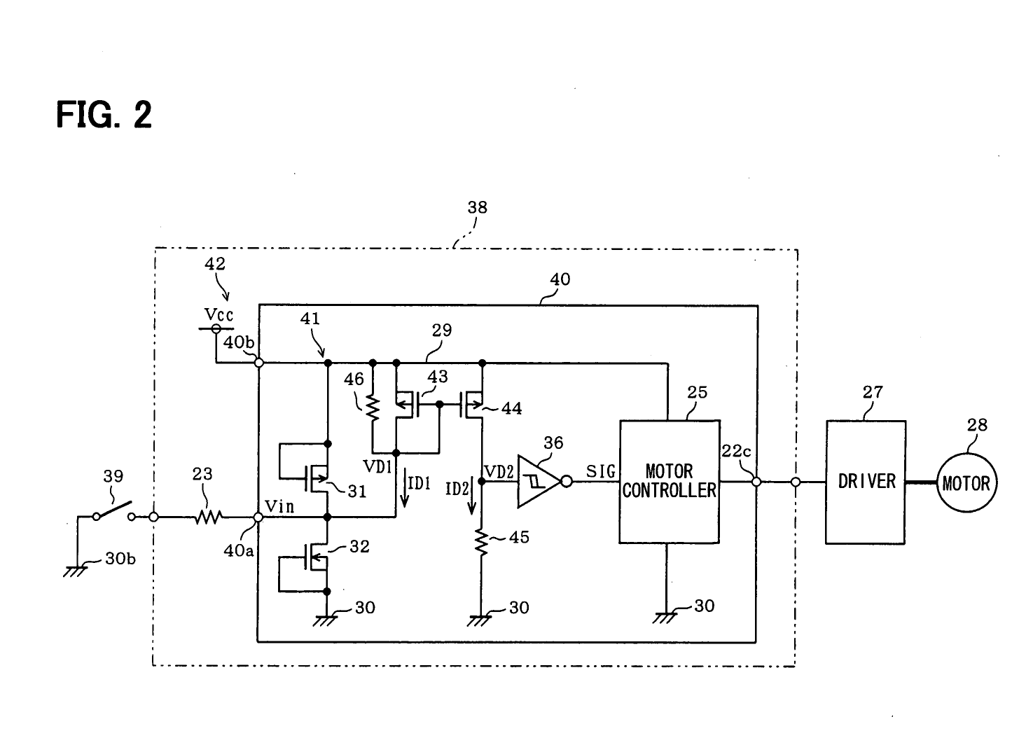

A control circuit 38 according to a second embodiment of the present invention is described below with reference to FIG. 2. A difference between the control circuit 21 of the first embodiment and the control circuit 38 of the second embodiment is as follows.

Like the control circuit 21 of the first embodiment, the control circuit 38 detects an ON/OFF state of a switch 39 and controls the blower motor 28. The control circuit 38 includes an IC 40 fabricated in a low voltage CMOS process and the protection resistor 23 externally added to the IC 40. The IC 40 is powered by the power supply voltage Vcc supplied through a power terminal 40b from a power supply circuit (not shown). The IC 40 includes an input processing circuit 41 and the motor control circuit 25. The input processing circuit 41 and the protection resistor 23 constructs a switch input circuit 42.

The input processing circuit 41 includes the input protection diodes 31, 32, P-channel MOSFETs 43, 44, a resistor 45, the Schmitt inverter 36, and a clamp resistor 46 having a high resistance. Each of the input protection diodes 31, 32 is constructed with a MOSFET, the gate and the source of which are coupled together to serve as a diode. The MOSFETs 43, 44 construct a current mirror circuit, and the sources of the MOSFETs 43, 44 are coupled to the power line 29. The resistor 45 is coupled between the drain of the MOSFET 44 and the ground line 30. The clamp resistor 46 is coupled between the gate and the source of the MOSFET 43.

The switch input circuit 42 works in the similar way to the switch input circuit 26. When the switch 39 is tuned on, the current ID1 flows from the power line 29 through the MOSFET 43 and the protection resistor 23, and the current ID2 flows through the MOSFET 44. The current ID2 depends on a size ratio (W/L ratio) between the MOSFETs 43, 44. When a drain voltage VD2 increases above the upper inverter threshold Vp of the Schmitt inverter 36, the detection signal SIG outputted from the Schmitt inverter 36 changes from high to low so that the switch input circuit 42 detects that the switch 39 is turned on. In contrast, when the switch 39 is tuned off, the drain voltage VD2 decreases below the lower inverter threshold Vn of the Schmitt inverter 36. Therefore, the detection signal SIG outputted from the Schmitt inverter 36 changes from low to high so that the switch input circuit 42 detects that the switch 39 is turned off.

In the second embodiment, the switch 39 is coupled at one end to a chassis ground 30b of the vehicle. When an electric load varies, a voltage of up to 2 volts may appear between the chassis ground 30b and the ground line 30 of the control circuit 38. If an electric potential of the chassis ground 30b becomes less than an electric potential of the ground line 30 by at least the forward-bias voltage Vf of the input protection diode 32, an electric current may flow from the ground line 30 to the chassis ground 30b through the input protection diode 32 and the protection resistor 23. In this case, the input voltage Vin appears at the input terminal 40a is clamped to (Vcc−VGS), because the MOSFET 43 is turned on. To prevent the electric current flowing to the chassis ground 30b through the input protection diode 32, it is preferable that the following inequality be satisfied:

(Vcc−VGS)>−Vf (9)

### Third Embodiment

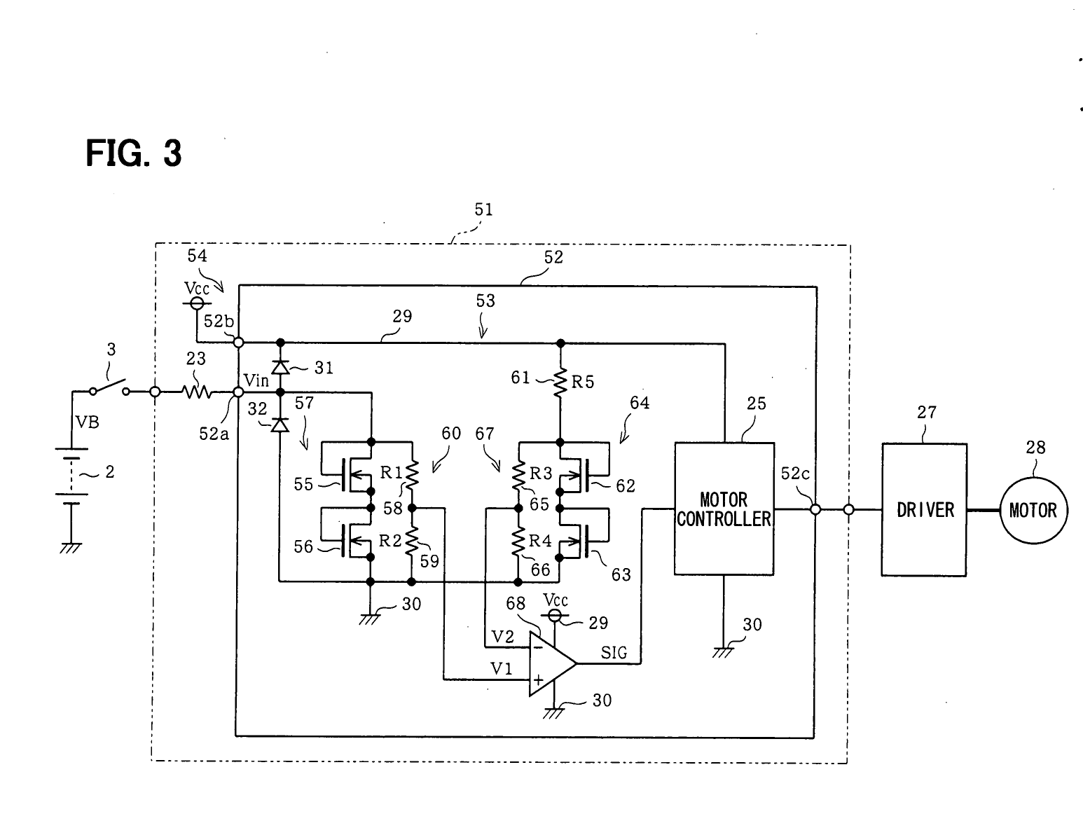

A control circuit 51 according to a third embodiment of the present invention is described below with reference to FIGS. 3-5. A difference between the control circuit 21 of the first embodiment and the control circuit 51 of the third embodiment is as follows.

The control circuit 51 includes an IC 52 fabricated in a low voltage CMOS process and the protection resistor 23 externally added to the IC 52. The protection resistor 23 is coupled between the ignition switch 3 and an input terminal 52a of the IC 52. The IC 52 includes an input processing circuit 53 and the motor control circuit 25. The input processing circuit 53 and the protection resistor 23 constructs a switch input circuit 54. The switch input circuit 54 detects the ON/OFF state of the ignition switch 3 and outputs the detection signal SIG indicative of the detected ON/OFF state to the motor control circuit 25.

The IC 52 is powered by a power supply voltage Vcc (e.g., 5 volts) supplied through a power terminal 52b from a power supply circuit (not shown). The input processing circuit 24 includes the input protection diodes 31, 32. A first clamp circuit 57 constructed with N-channel MOSFETs 55, 56 connected in series is coupled between the input terminal 52a of the IC 52 and the ground line 30. A first voltage divider circuit 60 constructed with resistors 58, 59 connected in series is connected in parallel with the first clamp circuit 57. The first voltage divider circuit 60 divides a first voltage across the first clamp circuit 57 and outputs the divided first voltage as a detection voltage V1.

A second clamp circuit 64 constructed with N-channel MOSFETs 55, 56 connected in series is coupled through a resistor 65 between the power line 29 and the ground line 30. A second voltage divider circuit 67 constructed with resistors 65, 66 connected in series is connected in parallel with the second clamp circuit 64. The second voltage divider circuit 67 divides a second voltage across the first clamp circuit 57 and outputs the divided second voltage as a reference voltage V2.

The MOSFETs 55, 56, 62, 63 are identical in size and characteristics. The resistors 58, 59, 65, 66 have resistances R1, R2, R3, R4, respectively. The resistances R1, R2, R3, R4 satisfy the following relationship:

R1:R2=0.5:10 (10)

R3:R4=1:9.5 (11)

R1 +R2=R3+R4 (12)

Further, it is preferable that the resistances R1, R2, R3, R4 are set such that when the detection voltage V1 is equal to the reference voltage V2, an electric current flowing through the MOSFETs 55, 56 becomes equal to an electric current flowing through the MOSFETs 62, 63.

The detection voltage V1 is applied to a non-inverting input of a comparator 68 serving as a detection circuit. The reference voltage V2 is applied to an inverting input of the comparator 68. The comparator 68 compares the detection voltage V1 with the reference voltage V2 and outputs a detection signal SIG to the motor control circuit 25. The resistors 58, 65 serve to protect the comparator 68 from static electricity.

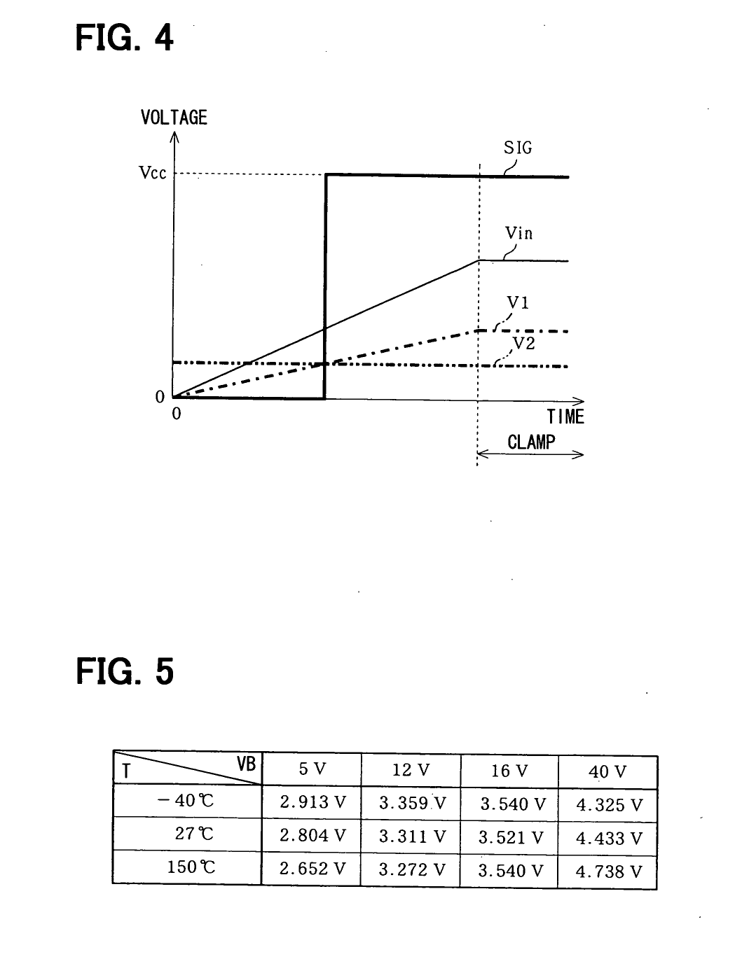

The operation of the switch input circuit 54 is described below with further reference to FIGS. 4, 5. During a period of time when the power supply voltage Vcc (e.g., 5 volts) is applied between the power line 29 and the ground line 30, the voltage drop across the second clamp circuit 64 becomes 2·VGS, where VGS is a gate-source voltage of each of the MOSFETs 62, 63. The reference voltage V2 outputted from the second voltage divider circuit 67 at a constant temperature is given by the following equation:

V2=2·VGS·R4/(R3+R4)=1.81·VGS (13)

As can be seen from the above equation (13), the reference voltage V2 is constant.

When the battery voltage VB increases with time under the condition where the ignition switch 3 is on, the detection signal SIG, the input voltage Vin, the detection voltage V1, and the reference voltage V2 change approximately as shown in FIG. 4. When the battery voltage VB is less than the voltage drop (i.e., 2·VGS) across the first clamp circuit 60, each of the input voltage Vin and the detection voltage V1 increases in proportion to the battery voltage VB. Then, when the input voltage Vin reaches 2·VGS, the MOSFETs 55, 56 are turned on so that the input voltage Vin is clamped to 2·VGS. At this time, the detection voltage V1 reaches a constant value given by the following equation:

V1=2·VGS·R2/(R1+R2)=1.905·VGS (14)

As can be seen from the equations (13), (14), the detection signal SIG changes from low to high by the time the input voltage Vin is clamped to 2·VGS after the battery voltage VB increases. Therefore, when the ignition switch 3 is turned on, the input voltage Vin is clamped to 2·VGS, except for the case where the battery voltage VB is very small. As a result, the detection signal SIG changes from low to high, and the switch input circuit 54 detects that the ignition switch 3 is turned on. In contrast, when the ignition switch 3 is turned off, the detection signal SIG changes from high to low. As a result, the switch input circuit 54 detects that the ignition switch 3 is turned off.

If the power supply circuit, which is not shown in the drawings and supplies the power supply voltage Vcc to the IC 52, is a series regulator, the power supply voltage Vcc may increase due to an electric current that flows from the input terminal 52a into the power supply circuit through the input protection diode 31 and the power line 29. To prevent the electric current flowing into the power supply circuit, it is preferable that the following inequality be satisfied:

Vcc>(2·VGS−Vf) (15)

The first clamp circuit 57 has input and output characteristics shown in FIG. 5. The input and output characteristics are determined by conducting an experiment in which the voltage drop across the first clamp circuit 57 is measured at temperatures minus 40 degrees Celsius (° C.), plus 27° C., plus 150° C. In the experiment, the first clamp circuit 57 is coupled to the protection resistor 23 and is not coupled to the first voltage divider circuit 60. As can been seen from FIG. 5, the voltage drop across the first clamp circuit 57 increases with an increase in the batter voltage VB and varies up to 10 percent due to variation in temperature.

Using a bandgap reference circuit can generate the reference voltage V2. However, the use of the bandgap reference circuit results in an increase in size and tends to cause a detection error due to variation in temperature. To prevent these problems, according to the third embodiment, the reference voltage V2 is generated by using the second clamp circuit 64, which has the same structure as the first clamp circuit 57. In such an approach, size of a reference voltage generation circuit for generating the reference voltage V2 is reduced. Further, since the reference voltage V2 has the same temperature dependence as the detection voltage V1, the detection error due to variation in temperature can be surely prevented.

As described above, according to the third embodiment, the switch input circuit 54 includes the protection resistor 23 and the IC 52 having the input processing circuit 54. The switch input circuit 54 can be constructed simply by externally adding the protection resistor 23 between the ignition switch 3 and the input terminal 52a of the IC 52. Therefore, the manufacturing cost and size of the switch input circuit 54 can be reduced as compared to the prior art illustrated in FIGS. 8, 9.

The input voltage Vin can be surely maintained below 2·VGS (up to about 4.7 volts) by adjusting the W/L size of the MOSFETs 55, 56 of the first clamp circuit 57, even if the battery voltage VB increases to 40 volts, for example, due to a load dump. Therefore, the IC 52 can be fabricated in a low voltage CMOS process that withstands the power supply voltage Vcc.

The potential of the battery 2 greatly varies due to load variations of other on-board devices connected to the battery 2. As a result, a voltage of up to 2 volts may appear between the ground potential of the battery 2 and the ground line 30 of the control circuit 51. Since the first clamp circuit 57 is constructed with two MOSFETs 55, 56 connected in cascade (i.e., series), application of voltage of 2 volts cannot turn on the first clamp circuit 57. Therefore, even if the potential of the battery 2 varies, the switch input circuit 54 can correctly detect the ON/OFF state of the ignition switch 3.

The second clamp circuit 64 generates the constant reference voltage V2. In such an approach, when the power supply voltage Vcc increases, the switch input circuit 54 can be prevented from incorrectly detecting that the ignition switch 3 is off, despite that the ignition switch 3 is on. Further, the first clamp circuit 57 for clamping the input voltage Vin has the same structure as the second clamp circuit 64 for generating the reference voltage V2. Specifically, the first and second clamp circuits 57, 64 are constructed with the same number and characteristic of MOSFETs connected in cascade. Therefore, the switch input circuit 54 can correctly detect the ON/OFF state of the ignition switch 3 even under an environment (e.g., in a vehicle) in which a temperature is likely to vary.

The first and second clamp circuits 57, 64 are respectively coupled with the first and second voltage divider circuits 60, 67. Therefore, the threshold of the comparator 68 can be easily adjusted by adjusting voltage division ratios of the first and second voltage divider circuits 60, 67. Further, turnoff time of the MOSFETs 55, 56 is reduced, so that the gate potential of the MOSFETs 55, 56 can be surely fixed to the potential of the ground line 30 when the ignition switch 3 is tuned off.

### Fourth Embodiment

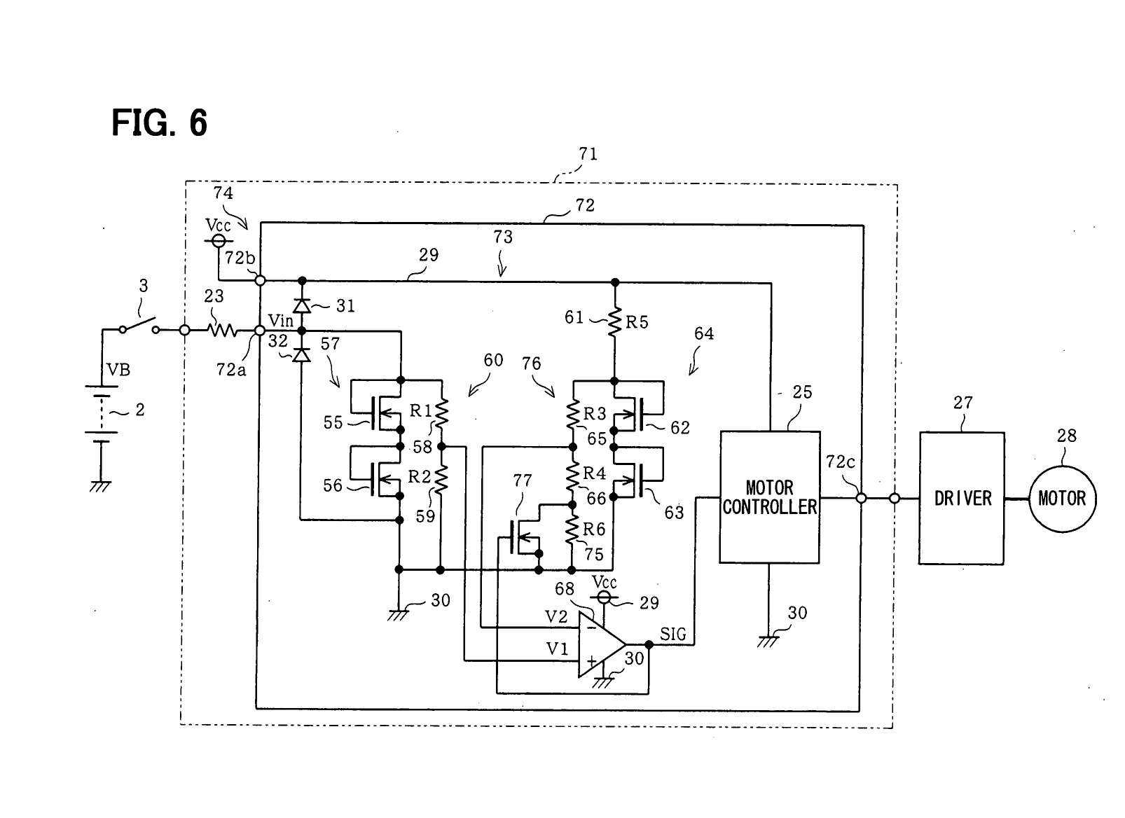

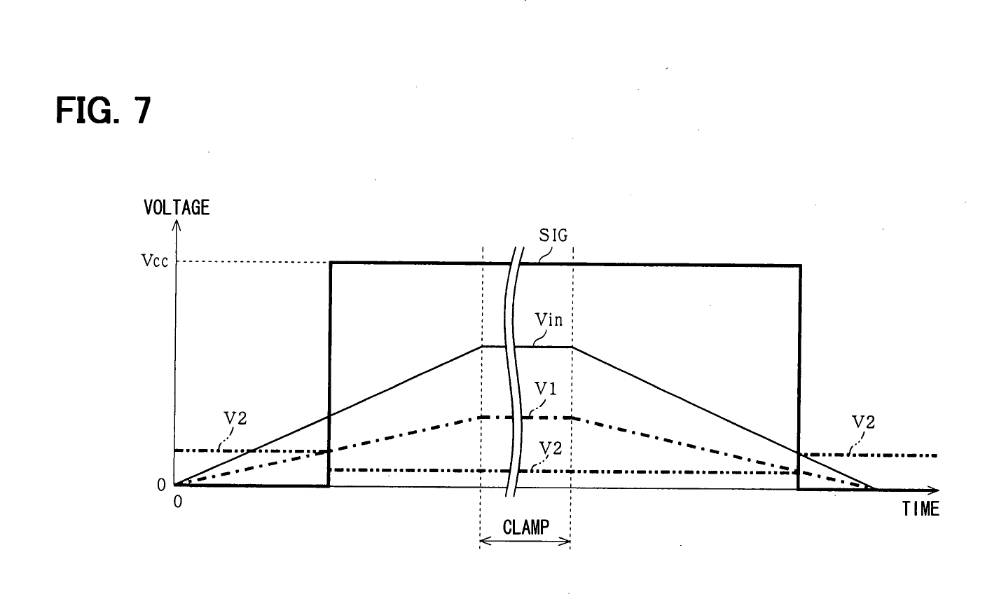

A control circuit 71 according to a fourth embodiment of the present invention is described below with reference to FIGS. 6, 7. The control circuit 71 includes an IC 72 fabricated in a low voltage CMOS process and the protection resistor 23 externally added to the IC 72. The protection resistor 23 is coupled between the ignition switch 3 and an input terminal 72a of the IC 72. The IC 72 includes an input processing circuit 73 and the motor control circuit 25. The input processing circuit 73 and the protection resistor 23 constructs a switch input circuit 74.

A difference between the switch input circuit 54 of the third embodiment and the switch input circuit 74 of the fourth embodiment is that the switch input circuit 74 has hysteresis characteristics. Specifically, the switch input circuit 74 includes a second voltage divider circuit 76 instead of the second voltage divider circuit 67 of the switch input circuit 54. The second voltage divider circuit 76 includes resistors 65, 66, 75 connected in series and is connected in parallel with the second clamp circuit 64. The reference voltage V2 generated by dividing the voltage drop across the second clamp circuit 64 is outputted from a junction between the resistors 65, 66. An N-channel MOSFET 77 is connected in parallel with the resistor 75, and the detection signal SIG outputted from the comparator 68 is applied to the gate of the MOSFET 77.

When the battery voltage VB increases and then decreases with time under the condition where the ignition switch 3 is on, the detection signal SIG, the input voltage Vin, the detection voltage V1, and the reference voltage V2 change approximately as shown in FIG. 7. During a period of time when the detection signal SIG is low, the reference voltage V2 is kept constant at a high level, because the MOSFET 77 is turned off. During a period of time when the detection signal SIG is high, the reference voltage V2 is kept constant at a low level, because the MOSFET 77 is turned on. Thus, the switch input circuit 74 has hysteresis characteristics, which prevents the detection signal SIG from frequently changing between high and low, for example, due to noise.

(Modifications)

The embodiments described above may be modified in various ways. For example, in the first and second embodiment, the resistors 35, 45 serving as a current-to-voltage converter can be replaced with an active circuit including a transistor. The Schmitt inverter 36 serving as a determination circuit can be replaced with a Schmitt circuit, an inverter circuit, a buffer circuit, a combination of a reference voltage generation circuit and a comparator, or the like. The clamp resistors 37, 46 can be option. The MOSFETs 33, 34, 43, 44 can be replaced with bipolar transistors.

The switch input circuits 26, 42, 54, 74 can detect an ON/OFF state of a switch other than the ignition switch 3 and the drive switch 39 of the blower motor 28. For example, the switch input circuits 26, 42, 54, 74 can detect an ON/OFF state of a door switch.

In the third and fourth embodiments, the first and second clamp circuits 57, 64 can be constructed with one or more than three MOSFETs connected in series. The MOSFETs 55, 56, 62, 63 of the first and second clamp circuits 57, 64 can be replaced with diodes or bipolar transistors connected by diodes.

Such changes and modifications are to be understood as being within the scope of the present invention as defined by the appended claims.

What is claimed is:

1. An input processing circuit implemented on a semiconductor integrated circuit and configured to be powered by a supply voltage supplied through first and second power lines, the input processing circuit comprising:
an input terminal for receiving an input signal;
first and second diodes, the first diode being coupled between the input terminal and the first power line, the second diode being coupled between the input terminal and the second power line;
a first transistor having first and second output electrodes and one control electrode, the first output electrode and the control electrode being coupled to the input terminal, the second output electrode being coupled to the second power line;
a second transistor coupled to the first transistor to construct a current mirror circuit;
a current-to-voltage conversion circuit coupled between the first power line and the second transistor and configured to convert an electric current flowing through the second transistor to a voltage; and
a determination circuit configured to determine a state of the input signal received by the input terminal based on a level of the output voltage of the current-to-voltage conversion circuit.

2. The input processing circuit according to claim 1, further comprising:
a resistor coupled between the second electrode and the control electrode of the first transistor to clamp a potential of the control electrode of the transistor to a potential of the second power line.

3. The input processing circuit according to claim 1, wherein the current-to-voltage conversion circuit includes a resistor.

4. The input processing circuit according to claim 1,
wherein the determination circuit includes a Schmitt circuit.

5. A switch input circuit for detecting an ON/OFF state of an external switch circuit, the switch input circuit comprising:
an input processing circuit defined in claim 1, and
a resistor coupled between the external switch circuit and the input terminal of the input processing circuit.

6. An input processing circuit implemented on a semiconductor integrated circuit and configured to be powered by a supply voltage supplied through first and second power lines, the input processing circuit comprising:
an input terminal for receiving an input signal;
first and second diodes, the first diode being coupled between the input terminal and the first power line, the second diode being coupled between the input terminal and the second power line;
a first clamp circuit coupled between the input terminal and the second power line and including at least one first transistor element connected in diode configuration;
a second clamp circuit coupled between the first and second power lines through a resistor, the second clamp circuit having a same structure as the first clamp circuit;
a first resistor circuit including at least one first resistor element coupled in parallel with the first clamp circuit, the first resistor circuit being configured to output a first voltage dependent on a voltage drop across the first clamp circuit;
a second resistor circuit including at least one second resistor element coupled in parallel with the second clamp circuit, the second resistor circuit being configured to output a second voltage dependent on a voltage drop across the second clamp circuit; and
a determination circuit configured to compare the first voltage with the second voltage and determine a state of the input signal received by the input terminal based on a result of the comparison.

7. The input processing circuit according to claim 6,
wherein the first resistor circuit includes a plurality of first resistor elements connected in series to construct a first voltage divider having a first division ratio,
wherein the first resistor circuit is configured to output the first voltage by dividing the voltage drop across the first clamp circuit by the first division ratio,
wherein the second resistor circuit includes a plurality of second resistor elements connected in series to construct a second voltage divider having a second division ratio, and
wherein the second resistor circuit is configured to output the second voltage by dividing the voltage drop across the second clamp circuit by the second division ratio.

8. The input processing circuit according to claim 7,
wherein the second resistor circuit further includes a second transistor element coupled in parallel with at least one of the plurality of second resistor elements, and
wherein the second transistor element is configured to be tuned on and off based on a result of the determination of the determination circuit.

9. The input processing circuit according to claim 6,
wherein each of the first and second clamp circuits includes at least one diode element instead of the first transistor element.

10. A switch input circuit for detecting an ON/OFF state of an external switch circuit, the switch input circuit comprising:
an input processing circuit defined in claim 6; and
a resistor coupled between the external switch circuit and the input terminal of the input processing circuit.
